(19) United States
(12) Patent Application Publication
(10) Pub. No.: US 2025/0325891 A1
(43) Pub. Date: Oct. 23, 2025

(54) CORNHOLE BOARD DEVICE

(71) Applicant: Adrianne Dost, Wheaton, IL (US)

(72) Inventor: Adrianne Dost, Wheaton, IL (US)

(21) Appl. No.: 18/640,579

(22) Filed: Apr. 19, 2024

(51) Int. Cl. A63B 67/06; B32B 3/26

(52) U.S. Cl. CPC A63B 67/06; B32B 3/266; A63B 2209/00; A63B 2210/50; B32B 2307/102; B32B 2307/56

(57) ABSTRACT

A cornhole board device includes a pair of cornhole boards which each has an aperture extending through a respective cornhole board to facilitate a cornhole bag to pass through the aperture when the cornhole bag is tossed onto the respective cornhole board. A pair of sets of sound insulating layers is each applied to a respective one of the plurality of cornhole boards. Each of the sets of sound insulating layers is comprised of a resiliently compressible material to reduce the intensity of sound produced by a cornhole bag is tossed onto the respective cornhole board. A pair of rigid panels is each positioned on top of a respective one of the pair of sets of sound insulating layers to absorb impact energy of the cornhole bags when the pair of cornhole bags is tossed onto the cornhole boards.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cornhole devices and more particularly pertains to a new cornhole device for reducing noise produced by a game of cornhole. The device includes a pair of cornhole boards which each includes a plurality of sound reducing layers and a rigid top layer thereby reducing noise produced by cornhole bags thrown onto the cornhole boards. The device additionally includes a pair legs pivotally attached to each of the cornhole boards to orient the cornhole boards at a sloped angle.

### (2) Description of Related Art Including Information Disclosed Under 37 CFR 1.97 and 1.98

The prior art relates to cornhole devices including a variety of bean bag tossing board devices which are structured to facilitate an angled plane upon which a bean bag can be tossed and a disk tossing game device which includes an angled board and a compressible layer applied to the angled board upon which a disk can be tossed and an object tossing game device which includes an angled board and a plurality of magnetized layers that are removably attachable to the angled board which includes graphics applied to one of the magnetized layers for customizing graphics. In no instance does the prior art disclose a cornhole board device that includes a cornhole board and a plurality of sound insulating layers each applied to the cornhole board for reducing the intensity of sound produced by a cornhole bag tossed onto the cornhole board.

### BRIEF SUMMARY OF THE INVENTION

An embodiment of the disclosure meets the needs presented above by generally comprising a pair of cornhole boards which each has an aperture extending through a respective cornhole board to facilitate a cornhole bag to pass through the aperture when the cornhole bag is tossed onto the respective cornhole board. A pair of sets of sound insulating layers is each applied to a respective one of the plurality of cornhole boards. Each of the sets of sound insulating layers is comprised of a resiliently compressible material to reduce the intensity of sound produced by a cornhole bag is tossed onto the respective cornhole board. A pair of rigid panels is each positioned on top of a respective one of the pair of sets of sound insulating layers to absorb impact energy of the cornhole bags when the pair of cornhole bags is tossed onto the cornhole boards.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cornhole board device according to an embodiment of the disclosure.

FIG. 2 is a bottom perspective view of an embodiment of the disclosure.

FIG. 3 is a back perspective view of an embodiment of the disclosure.

FIG. 4 is a top view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

### DETAILED DESCRIPTION OF THE INVENTION

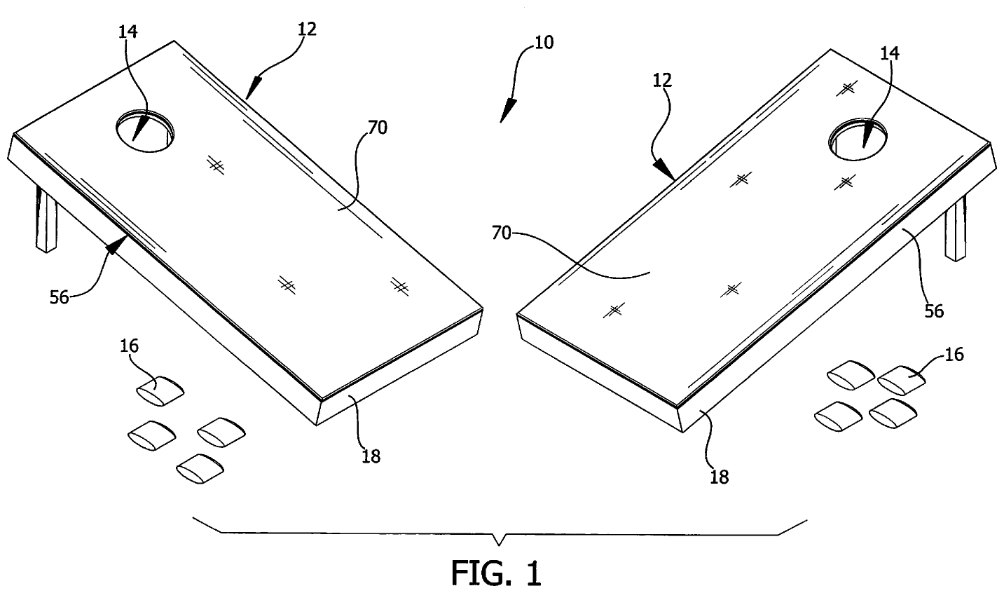

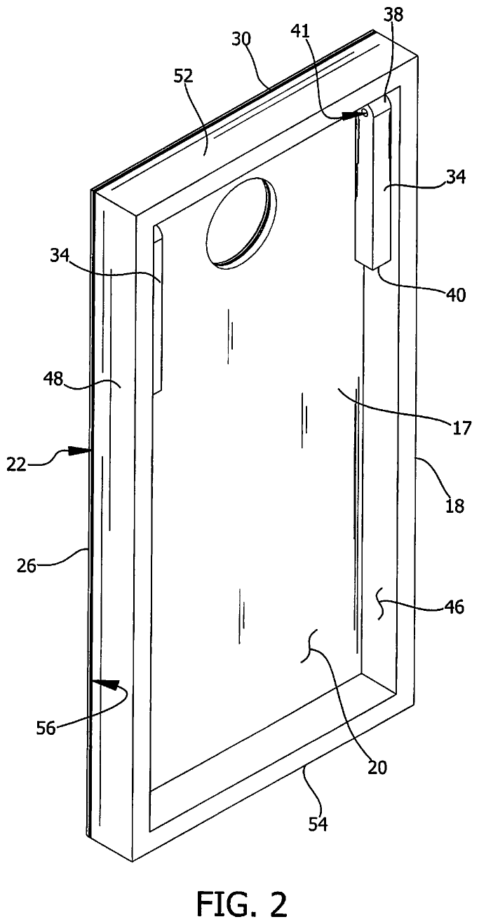

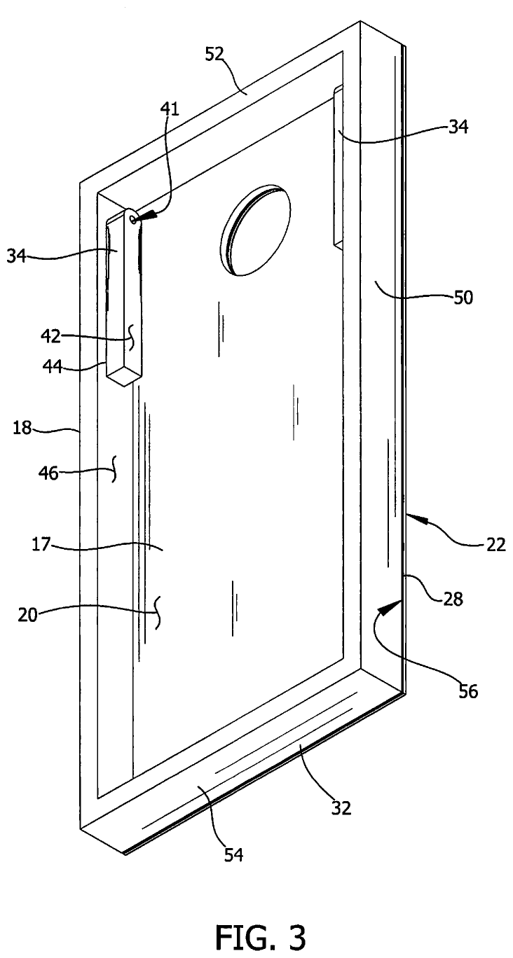

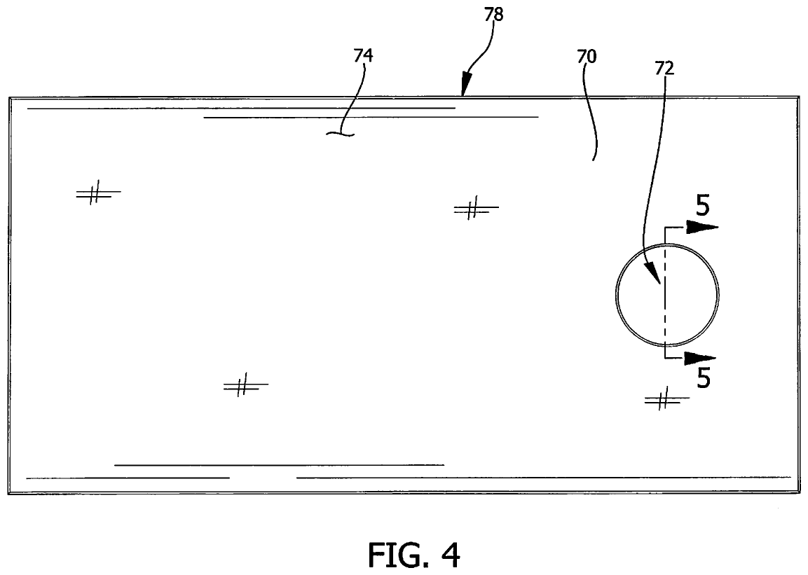

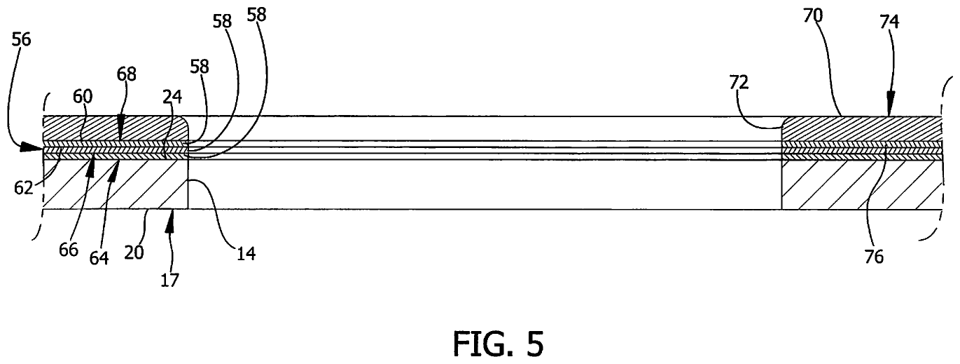

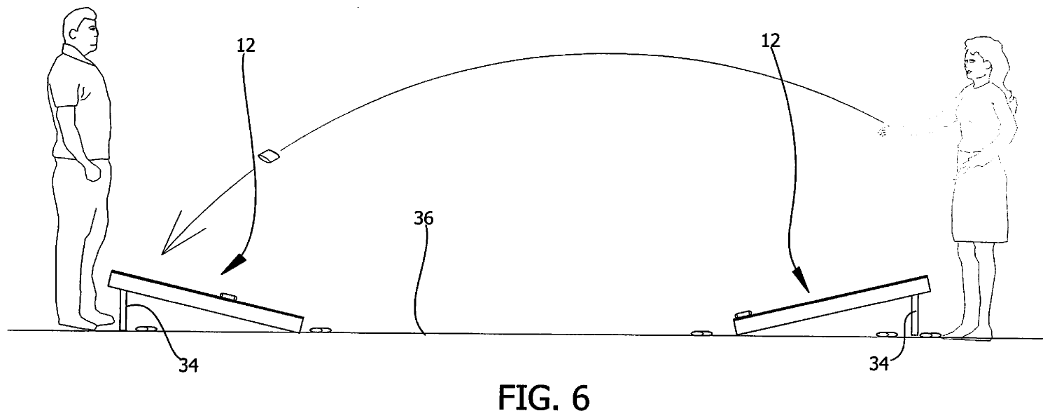

With reference now to the drawings, and in particular to FIGS. 1 through 6 thereof, a new cornhole device embodying the principles and concepts of an embodiment of the disclosure and generally designated by the reference numeral 10 will be described.

As best illustrated in FIGS. 1 through 6, the cornhole board device 10 generally comprises a pair of cornhole boards 12 which each has an aperture 14 extending through a respective cornhole board 12 to facilitate a cornhole bag 16 to pass through the aperture 14 when the cornhole bag 16 is tossed onto the respective cornhole board 12. Each of the pair of cornhole boards 12 has an upper panel 17 and a border 18 extending downwardly from a lower surface 20 of the upper panel 17. Additionally, the border 18 of each of the cornhole boards 12 is aligned with and is coextensive with a perimeter edge 22 of the upper panel 17. The aperture 14 of each of the pair of cornhole boards 12 extends through a top surface 24 and the lower surface 20 of the upper panel 17 of the respective cornhole board 12. The aperture 14 in each of the pair of cornhole boards 12 is centrally positioned between a first lateral side 26 and a second lateral side 28 of the perimeter edge 22 of the respective cornhole board 12. Furthermore, the aperture 14 in each of the pair of cornhole boards 12 is positioned closer to a back side 30 of the perimeter edge 22 of the respective cornhole board 12 than a front side 32 of the perimeter edge 22 of the respective cornhole board 12.

Each of the pair of cornhole boards 12 includes a pair of legs 34 which is each pivotally attached to a respective one of the pair of cornhole boards 12. Each of the pair of legs 34 on the respective cornhole board 12 is positionable in a deployed position having each of the pair of legs 34 on the respective cornhole board 12 extending downwardly from the respective cornhole board 12. In this way each of the pair of legs 34 on the respective cornhole board 12 can abut a support surface 36 upon which the respective cornhole board 12 is positioned thereby orienting the respective cornhole board 12 at an angle on the support surface 36. The support surface 36 may be the ground, a floor of a building or any other type of horizontal support surface. Additionally, each of the pair of legs 34 on the respective cornhole board 12 is positionable in a stored position.

Each of the pair of legs 34 on the respective cornhole board 12 has an upper end 38 and a lower end 40 and the upper end 38 of each of the pair of legs 34 on the respective cornhole board 12 is rounded. Each of the pair of legs 34 on the respective cornhole board 12 includes a pivot 41 extending through a first lateral surface 42 and a second lateral surface 44 of a respective leg 34. The pivot 41 on each of the pair of legs 34 of the respective cornhole board 12 is positioned closer to the upper end 38 than the lower end 40. Furthermore, the pivot 41 on each of the pair of legs 34 of the respective cornhole board 12 pivotally engages an inwardly facing surface 46 of a respective one of a first lateral member 48 and a second lateral member 50 of the border 18 on the respective cornhole board 12. Additionally, the pivot 41 on each of the pair of legs 34 of the respective cornhole board 12 is positioned closer to a back member 52 of the border 18 on the respective cornhole board 12 than a front member 54 of the border 18 on the respective cornhole board 12. Each of the pair of legs 34 on the respective cornhole board 12 extends along a line which is perpendicularly oriented with the lower surface 20 of the upper panel 17 of the respective cornhole board 12 when the pair of legs 34 is positioned in the deployed position. Conversely, each of the pair of legs 34 rests against the lower surface 20 of the upper panel 17 of the respective cornhole board 12 when the pair of legs 34 is positioned in the stored position.

A pair of sets of sound insulating layers 56 is provided and each of the pair of sets of sound insulating layers 56 is applied to a respective one of the plurality of cornhole boards 12. Each of the sets of sound insulating layers 56 is comprised of a resiliently compressible material, including but not being limited to rubber or silicone or foamed polyurethane. In this way each of the sets of sound insulating layers 56 can reduce the intensity of sound produced by the cornhole bag 16 being tossed onto the respective cornhole board 12. Each of the sets of sound insulating layers 56 has a hole 58 extending through an upper surface 60 and a lower surface 62 of a respective one of the sets of sound insulating layers 56.

The sets of sound insulating layers 56 includes a lowermost layer 64 and a middle layer 66 and an uppermost layer 68. The lower surface 62 of the lowermost layer 64 of each of the sets of sound insulating layers 56 is bonded to the upper surface 60 of the upper panel 17 of the respective cornhole board 12 having the hole 58 in the lowermost layer 64 of each of the sets of sound insulating layers 56 being aligned with the aperture 14 in the upper panel 17 of the respective cornhole board 12. The lower surface 62 of the middle layer 66 of a respective set of sound insulating layers 56 is bonded to the upper surface 60 of the lowermost layer 64 of the respective set of sound insulating layers 56 having the hole 58 in the middle layer 66 of the respective set of sound insulating layers 56 being aligned with the hole 58 in the lowermost layer 64 of the respective set of sound insulating layers 56. The lower surface 62 of the uppermost layer 68 of a respective set of sound insulating layers 56 is bonded to the upper surface 60 of the middle layer 66 of the respective set of sound insulating layers 56 having the hole 58 in the uppermost layer 68 of the respective set of sound insulating layers 56 being aligned with the hole 58 in the middle layer 66 of the respective set of sound insulating layers 56.

A pair of rigid panels 70 is provided and each of the pair of rigid panels 70 is positioned on top of a respective one of the pair of sets of sound insulating layers 56. Each of the pair of rigid panels 70 is comprised of a rigid material, including but not being limited to polyvinyl chloride or wood or nylon. In this way each of the pair of rigid panels 70 can absorb impact energy of the cornhole bags 16 when the pair of cornhole bags 16 is tossed onto the cornhole boards 12. Each of the pair of rigid panels 70 has an opening 72 extending through a topmost surface 74 and a bottommost surface 76 of a respective one of the pair of rigid panels 70. The bottommost surface 76 of each of the pair of rigid panels 70 is bonded to the upper surface 60 of the uppermost layer 68 of the respective set of sound insulating layers 56 having the opening 72 in each of the pair of rigid panels 70 being aligned with the hole 58 in the uppermost layer 68 of the respective set of sound insulating layers 56. Furthermore, each of the pair of rigid panels 70 completely covers the uppermost layer 68 of the respective set of sound insulating layers 56. Additionally, each of the pair of rigid panels 70 has a perimeter edge 78 which is rounded at an intersection between the perimeter edge 78 of the rigid panels 70 and the topmost surface 74 of the rigid panels 70.

In use, the legs 34 on each of the pair of cornhole boards 12 is positioned in the deployed position and the pair of cornhole boards 12 is positioned on the support surface 36 having the pair of cornhole boards 12 being spaced a preferred distance from each other. Additionally, each of the pair of cornhole boards 12 is oriented such that the front member 54 of the border 18 on each of the pair of cornhole boards 12 faces each other. The sets of sound insulating layers 56 on each of the pair of cornhole boards 12 reduces the intensity of sound produced by the cornhole bags 16 being tossed onto the pair of cornhole boards 12 during the game of cornhole. In this way people that are seated or standing near the pair of cornhole boards 12 can enjoy conversation or listen to music without the distracting noise of the cornhole bags 16 landing on the cornhole boards 12.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cornhole board device which has sound insulating layers to reduce the intensity of sound produced by cornhole bags during the game of cornhole, said device comprising:
a pair of cornhole boards, each of said pair of cornhole boards having an aperture extending through a respective cornhole board to facilitate a cornhole bag to pass through said aperture when said cornhole bag is tossed onto said respective cornhole board;
wherein each of said pair of cornhole boards includes a pair of legs each being pivotally attached to a respective one of said pair of cornhole boards, each of said pair of legs on said respective cornhole board being positionable in a deployed position having each of said pair of legs on said respective cornhole board extending downwardly from said respective cornhole board wherein each of said pair of legs on said respective cornhole board is configured to abut a support surface upon which said respective cornhole board is positioned, each of said pair of legs on said respective cornhole board being positionable in a stored position;
a pair of sets of sound insulating layers, each of said pair of sets of sound insulating layers being applied to a respective one of said plurality of cornhole boards, each of said sets of sound insulating layers being comprised of a resiliently compressible material wherein each of said sets of sound insulating layers is configured to reduce the intensity of sound produced by a cornhole bag being tossed onto said respective cornhole board; and
a pair of rigid panels, each of said pair of rigid panels being positioned on top of a respective one of said pair of sets of sound insulating layers, each of said pair of rigid panels being comprised of a rigid material wherein each of said pair of rigid panels is configured to absorb impact energy of said cornhole bags when said pair of cornhole bags is tossed onto said cornhole boards.

2. The device according to claim 1, wherein:
each of said pair of cornhole boards has an upper panel and a border extending downwardly from a lower surface of said upper panel;
said border of each of said cornhole boards is aligned with and is coextensive with a perimeter edge of said upper panel;
said aperture of each of said pair of cornhole boards extends through a top surface and said lower surface of said upper panel of said respective cornhole board;
said aperture in each of said pair of cornhole boards is centrally positioned between a first lateral side and a second lateral side of said perimeter edge of said respective cornhole board; and
said aperture in each of said pair of cornhole boards is positioned closer to a back side of said perimeter edge of said respective cornhole board than a front side of said perimeter edge of said respective cornhole board.

3. The device according to claim 2, wherein:
each of said pair of legs on said respective cornhole board has an upper end and a lower end;
said upper end of each of said pair of legs on said respective cornhole board is rounded;
each of said pair of legs on said respective cornhole board includes a pivot extending through a first lateral surface and a second lateral surface of a respective leg;
said pivot on each of said pair of legs of said respective cornhole board is positioned closer to said upper end than said lower end;
said pivot on each of said pair of legs of said respective cornhole board pivotally engages an inwardly facing surface of a respective one of a first lateral member and a second lateral member of said border on said respective cornhole board having said pivot on each of said pair of legs of said respective cornhole board being positioned closer to a back member of said border on said respective cornhole board than a front member of said border on said respective cornhole board;
each of said pair of legs on said respective cornhole board extends along a line being perpendicularly oriented with said lower surface of said upper panel of said respective cornhole board when said pair of legs is positioned in said deployed position; and
each of said pair of legs rests against said lower surface of said upper panel of said respective cornhole board when said pair of legs is positioned in said stored position.

4. The device according to claim 2, wherein:
each of said sets of sound insulating layers has a hole extending through an upper surface and a lower surface of a respective one of said sets of sound insulating layers;
said sets of sound insulating layers includes a lowermost sound insulating layer and a middle layer and an uppermost layer;
said lower surface of said lowermost layer of each of said sets of sound insulating layers is bonded to said upper surface of said upper panel of said respective cornhole board having said hole in said lowermost layer of each of said sets of sound insulating layers being aligned with said aperture in said upper panel of said respective cornhole board;
said lower surface of said middle layer of a respective set of sound insulating layers is bonded to said upper surface of said lowermost layer of said respective set of sound insulating layers having said hole in said middle layer of said respective set of sound insulating layers being aligned with said hole in said lowermost layer of said respective set of sound insulating layers; and
said lower surface of said uppermost layer of a respective set of sound insulating layers is bonded to said upper surface of said middle layer of said respective set of sound insulating layers having said hole in said uppermost layer of said respective set of sound insulating layers being aligned with said hole in said middle layer of said respective set of sound insulating layers.

5. The device according to claim 4, wherein:
each of said pair of rigid panels has an opening extending through a topmost surface and a bottommost surface of a respective one of said pair of rigid panels;
said bottommost surface of each of said pair of rigid panels is bonded to said upper surface of said uppermost layer of said respective set of sound insulating layers having said opening in each of said pair of rigid panels being aligned with said hole in said uppermost layer of said respective set of sound insulating layers having each of said pair of rigid panels completely covering said uppermost layer of said respective set of sound insulating layers; and
each of said pair of rigid panels has a perimeter edge being rounded at an intersection between said perimeter edge of said rigid panels and said topmost surface of said rigid panels.

6. A cornhole board device which has sound insulating layers to reduce the intensity of sound produced by cornhole bags during the game of cornhole, said device comprising:
a pair of cornhole boards, each of said pair of cornhole boards having an aperture extending through a respective cornhole board to facilitate a cornhole bag to pass through said aperture when said cornhole bag is tossed onto said respective cornhole board, each of said pair of cornhole boards having an upper panel and a border extending downwardly from a lower surface of said upper panel, said border of each of said cornhole boards being aligned with and being coextensive with a perimeter edge of said upper panel, said aperture of each of said pair of cornhole boards extending through a top surface and said lower surface of said upper panel of said respective cornhole board, said aperture in each of said pair of cornhole boards being centrally positioned between a first lateral side and a second lateral side of said perimeter edge of said respective cornhole board, said aperture in each of said pair of cornhole boards being positioned closer to a back side of said perimeter edge of said respective cornhole board than a front side of said perimeter edge of said respective cornhole board;
wherein each of said pair of cornhole boards includes a pair of legs each being pivotally attached to a respective one of said pair of cornhole boards, each of said pair of legs on said respective cornhole board being positionable in a deployed position having each of said pair of legs on said respective cornhole board extending downwardly from said respective cornhole board wherein each of said pair of legs on said respective cornhole board is configured to abut a support surface upon which said respective cornhole board is positioned, each of said pair of legs on said respective cornhole board being positionable in a stored position, each of said pair of legs on said respective cornhole board having an upper end and a lower end, said upper end of each of said pair of legs on said respective cornhole board being rounded, each of said pair of legs on said respective cornhole board including a pivot extending through a first lateral surface and a second lateral surface of a respective leg, said pivot on each of said pair of legs of said respective cornhole board being positioned closer to said upper end than said lower end, said pivot on each of said pair of legs of said respective cornhole board pivotally engaging an inwardly facing surface of a respective one of a first lateral member and a second lateral member of said border on said respective cornhole board having said pivot on each of said pair of legs of said respective cornhole board being positioned closer to a back member of said border on said respective cornhole board than a front member of said border on said respective cornhole board, each of said pair of legs on said respective cornhole board extending along a line being perpendicularly oriented with said lower surface of said upper panel of said respective cornhole board when said pair of legs is positioned in said deployed position, each of said pair of legs resting against said lower surface of said upper panel of said respective cornhole board when said pair of legs is positioned in said stored position;
a pair of sets of sound insulating layers, each of said pair of sets of sound insulating layers being applied to a respective one of said plurality of cornhole boards, each of said sets of sound insulating layers being comprised of a resiliently compressible material wherein each of said sets of sound insulating layers is configured to reduce the intensity of sound produced by a cornhole bag being tossed onto said respective cornhole board, each of said sets of sound insulating layers having a hole extending through an upper surface and a lower surface of a respective one of said sets of sound insulating layers, said sets of sound insulating layers including a lowermost sound insulating layer and a middle layer and an uppermost layer, said lower surface of said lowermost layer of each of said sets of sound insulating layers being bonded to said upper surface of said upper panel of said respective cornhole board having said hole in said lowermost layer of each of said sets of sound insulating layers being aligned with said aperture in said upper panel of said respective cornhole board, said lower surface of said middle layer of a respective set of sound insulating layers being bonded to said upper surface of said lowermost layer of said respective set of sound insulating layers having said hole in said middle layer of said respective set of sound insulating layers being aligned with said hole in said lowermost layer of said respective set of sound insulating layers, said lower surface of said uppermost layer of a respective set of sound insulating layers being bonded to said upper surface of said middle layer of said respective set of sound insulating layers having said hole in said uppermost layer of said respective set of sound insulating layers being aligned with said hole in said middle layer of said respective set of sound insulating layers; and
a pair of rigid panels, each of said pair of rigid panels being positioned on top of a respective one of said pair of sets of sound insulating layers, each of said pair of rigid panels being comprised of a rigid material wherein each of said pair of rigid panels is configured to absorb impact energy of said cornhole bags when said pair of cornhole bags is tossed onto said cornhole boards, each of said pair of rigid panels having an opening extending through a topmost surface and a bottommost surface of a respective one of said pair of rigid panels, said bottommost surface of each of said pair of rigid panels being bonded to said upper surface of said uppermost layer of said respective set of sound insulating layers having said opening in each of said pair of rigid panels being aligned with said hole in said uppermost layer of said respective set of sound insulating layers having each of said pair of rigid panels completely covering said uppermost layer of said respective set of sound insulating layers, each of said pair of rigid panels having a perimeter edge being rounded at an intersection between said perimeter edge of said rigid panels and said topmost surface of said rigid panels.
